(19) United States
(12) Patent Application Publication
(10) Pub. No.: US 2008/0001737 A1
(43) Pub. Date: Jan. 3, 2008

(54) EVENT-SENSING LABEL

(75) Inventor: Jean-Michel Metry, Sion (CH)

Correspondence Address: FOLEY & LARDNER LLP, 1530 PAGE MILL ROAD, PALO ALTO, CA, 94304, US

(73) Assignee: Aardex Ltd.

(21) Appl. No.: 11/770,665

(22) Filed: Jun. 28, 2007

Related U.S. Application Data
(60) Provisional application No. 60/817,980, filed on Jun. 30, 2006.

(51) Int. Cl. G08B 21/00

(52) U.S. Cl. 340/540

(57) ABSTRACT

A label which notes the manipulation of objects which it labels by generating an altered electrical signature is provided.

### CROSS-REFERENCE TO RELATED PATENT APPLICATIONS

This application claims priority from Provisional Application U.S. Application No. 60/817,980, filed Jun. 30, 2006, incorporated herein by reference in its entirety.

### FIELD OF THE INVENTION

This invention relates to a label which can provide an electrical signal indicative of the status of the object to which the label is affixed. In preferred embodiments it relates to the use of such labels in connection with dispensers of unit dose medications having a desired dispensing regimen and, in particular, to the use of such labels to sense medication events with such dispensers which gather and process information on patient compliance with the desired dispensing regimen.

### BACKGROUND OF THE INVENTION

There are numerous settings where it is advantageous to have an indication of the status of an object. For example, there are settings where it is of importance to know if an object is intact or if it has been tampered with or accessed, and the time at which the tampering or access occurred. These settings include security labeling or tamper-proof packages for foods or beverages or pharmaceuticals. It is possible to incorporate devices which will provide this security and this information directly into the packaging for the objects. However, there are many times when it is inconvenient to do this or where a variety of different packaging is presented such that a great variety of devices would be needed to accommodate the range of packages.

In the field of pharmaceuticals there is a growing appreciation that monitoring the timeliness and consistency of medication administration can lead to better patient compliance with desired dosing plans and to a better understanding of the drug's effectiveness on a patient-by-patient basis. Today, this sort of information is gathered and stored electronically in virtually all cases. In these settings there is a need to have an easy-to-use type of detector to note the drug dispensing events. It is also helpful if that detector can be relatively universal and readily adapted to detect dispensing from a range of drug containers and drug presentation formats. It should also be simple of construction and robust and not prone to the generation of “false positive” dose detection errors in which a false indication of dosing is generated. The present invention satisfies all of these needs.

There is a special interest in the application of this invention to the field of pharmaceuticals and the assurance of the purity and proper administration of drug dosage forms. However, this invention can find application far beyond this field.

### SUMMARY OF THE INVENTION

It is a principal object of this invention to provide a conductive label capable of providing a changed electrical signal as a function of whether or not or how many times an object labeled with the label has been physically accessed or otherwise manipulated.

It is an additional object to provide a system including such a label which system can sense and employ information about whether or not or how many times an object labeled with the label has been accessed or otherwise manipulated.

It is an additional object to provide such a label and such a system which can be employed in medication compliance monitoring systems.

A further object of the invention is to provide such a label and system incorporating this label which can be employed in improved medication compliance monitoring systems that can gather data concerning patient dosing of medications and store and optionally communicate the data concerning stored medication dosing events.

Thus, in one aspect this invention enables an electrical-signal-providing label for attachment to an object such as a container and suitable for detecting one or more manual events, such as physical accessing involving the object and a system including such a label for using the detection of the event that the label provides. The label includes a stack of layers and an adhesive coating. In will also commonly include a disposable protective layer over the adhesive coating that is removed prior to affixing the label to the object. The stack of layers includes at least three layers. The first layer is a flexible, conformable layer made of or coated with an electrically conductive or semiconductive material. The second layer is made of a flexible, deformable, and compressible material. This second layer may be nonconductive or it may be electrically conductive but less conductive than the first layer. The third layer is typically similar to or like the first layer. It is flexible and conformable and is made of or contains a coating of flexible, conformable, electrically conductive or semi conductive material. The second layer physically and electrically separates the first and third layers and creates a characteristic electrical “signature” for the three layer stack which varies if and when the second layer is deformed or compressed. This electrical “signature” can be a conductivity value, a resistance value, a capacitance value or an induction value measured across the first and third layers and the intermediate second layer with and without deformation or compression. The first and third layers each have at least one electrical contact point to which electrical connection can be made for purposes of detecting the electrical signature and/or the variations in it measured across the three layers which occur when the object to which the label is affixed undergoes manipulation or access and the second layer is deformed or compressed.

If the intermediate second layer is completely resilient such that it returns to tits original configuration after manipulation or deformation, then the signature should essentially return to its original value, as well. In this case, if multiple events are being detected, they may each present a similar signature from the baseline signature value. This will result in a change in signature which is not additive as multiple events are detected. If, however, the second layer is not completely resilient such that it does not essentially completely return to its configuration after manipulation or deformation each successive deformation or compression may produce a change in signature which is, at least in part, additive with the original value and thus distinguishable from the initial change in signature.

In some embodiments of the invention it will be desired to detect a series of several events occurring over an area and it may be desired to identify which of the several events is being detected. This could occur, for example, if one were detecting the delivery of a series of doses of two or more drugs from a single membrane type array such as found with oral contraceptives. Often the two-connection configuration described above, with one connection being made to the conductive first layer and the second connection being made to the conductive third layer can provide this information with the compression or deformation of certain areas of the second layer yielding distinguishable signatures as compared to compression or deformation of other areas of the second layer. Alternatively, it may be helpful to have one or more, say one to four, additional connections to one or both of the first and third layers with the extra connection or connections being spaced apart from the first and second connections. It will be seen that different signatures are detected across various combinations of these multiple connections and that these different signatures will distinguish among compressions/distortions of different locations in the second layer and thus provide information concerning the particular event being detected, such as, for example in the oral contraceptive setting just mentioned, the particular drug being dispensed.

The label includes an adhesive coating which is suitable for adhering the label made up of the stack of layers to the object in a location selected to receive a second-layer-deforming or compressing force when the object is accessed or otherwise manipulated.

This label can be combined with an electrical detection circuit which detects variations in the electrical signature of the label. In one representative embodiment this circuit can feed a first fed electrical signal across the first and third layers. The circuit can then detect a first output signal across the first and third layers with the label in place attached to the object and no access to the object having been achieved. This provides a base electrical value for the signature which the detection circuit can read. Thereafter the circuit feeds a second fed electrical signal across the first and third layers with the label in place and detects a second output signal across the first and third layers. The first and second output signals are the same or at least similar to each other if no access to the object has been achieved. The first and second output signals differ from one another in a characteristic way if the second layer is being or has been compressed or deformed as a result of the object having been manipulated or accessed The circuit can include processors, indicators, memories, data transmitters and the like which can gather, store, and display or transmit information concerning manipulation or accessing of the object based upon the detected similarities or differences between the first and second output signals provided by these labels.

In a favored aspect, this invention provides an electrical-signal-providing label system for detecting the dispensing of one or more doses of medication from a container to a patient. In this aspect the label as just described is suitably associated with, e.g. adhered to, a medication dose container or as part of packaging for the dose or doses of medication. The label is located such that proper manipulation of the medication container, for example the opening or opening and closing of the container, the working of a child-proof closure, the pushing of a lever to actuate an inhaler or the “bursting” of a pill from a “blister pack” or other flat format packaging will provide the needed second-layer-compressing force which alters the electrical signature and provides the indication of accessing or other manipulation of the medication dispenser. In most applications, the label is affixed to the container or packaging at this desired operative location. It will be appreciated that it is desirable to choose the location for the label to maximize the detection of actual accessing or manipulation events and to minimize the detection of spurious events

In a further aspect the label of this invention can detect a series of accessing or manipulation events involving an object or a series of objects. In this case the label can remain as just described. The detection circuit can remain essentially the same, as well. In this case, the label is placed on the object in a location selected to receive a second-layer-compressing or distorting force each time the object is accessed and the electrical detection circuit is capable of gathering information in the form of a series of electrical signals. In this case, each time the object is accessed or manipulated, additional second-layer-compressive or distortive forces are applied to the second layer and the output signal (i.e. electrical signature of the label) is altered in a characteristic manner or in characteristic manners which can be detected and used as a record of the one or more accessings or manipulations. In preferred embodiments, this can be used to detect the delivery of a series of doses of a medication. The accessing of different objects can give rise to different signatures. Accordingly, in this aspect, it may be advantageous to employ a detection circuit which can distinguish among the different signatures.

It will be appreciated by those of skill in the art that this label and label-detector combination has the potential to be quite universal in size and applicability. It will be further recognized that it can be used with a wide range of existing packages for objects and especially for the full range of existing medication dosage formats and dosage forms. The label does not involve complicated wire or printed traces but rather employs a robust stack of substantially uniform simple layered materials which is simply added to (adhered to) existing drug packaging. There is no reason to believe that it will not serve well with additional packaging such as new drug dosage forms or new dosage form containers as they are developed hereafter.

### DETAILED DESCRIPTION OF THE INVENTION

### BRIEF DESCRIPTION OF THE DRAWINGS

FIGS. 1A and 1B are a pair of schematic, partially cross-sectional views of an event-sensing label and its combination with a detector system according to the present invention used with a container. In FIG. 1A the label is shown before the sensed event takes place. In FIG. 1B the label is shown as the sensed event is taking place.

FIG. 2 is a schematic, partially cross-sectional view of an event-sensing label and its combination with a detector system according to the present invention and a container depicting schematically the placement of the detector circuitry into the lid of the container.

FIGS. 3A, 3B and 3C are three schematic, partially cross-sectional views of an event-sensing label and its combination with a detector system according to the present invention used with a conventional blister pack. In FIG. 3A the label is shown before any sensed events take place. In FIG. 3B the label is shown as a first sensed event is taking place. In FIG. 3C the label is shown as a second sensed event is taking place.

### DESCRIPTION OF PREFERRED EMBODIMENTS

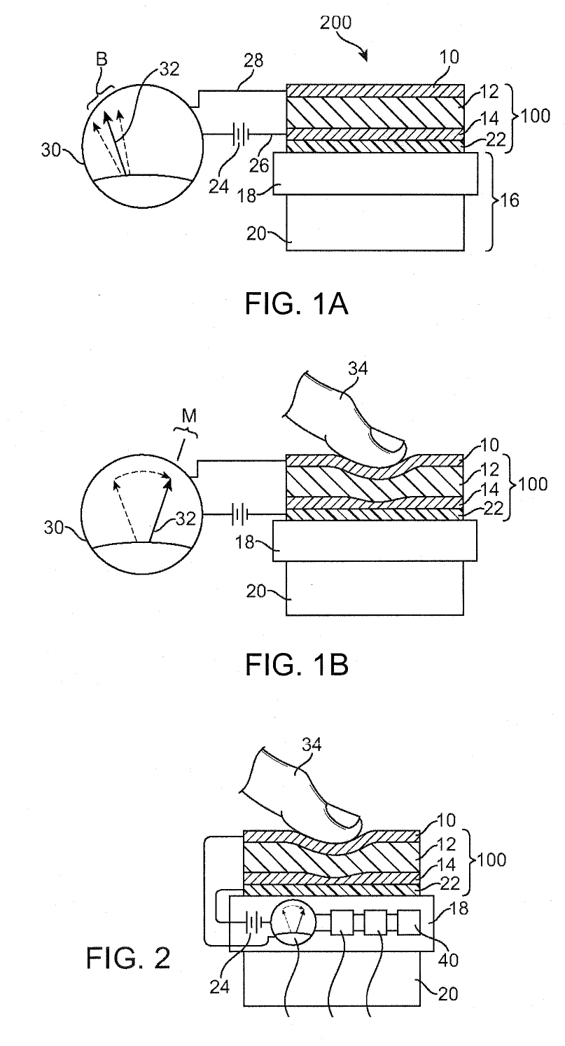

Referring to FIGS. 1 and 2, a label 100 and overall system 200 are shown. As the term “label” connotes, the device 100 is substantially two-dimensional , having a thickness that is relatively small as compared to its length and width. Label 100 includes a first layer 10, a second layer 12 and a third layer 14. First layer 10 and third layer 14 are each a conductive or semiconductive layer. Preferably, they are each layers having a conductivity of at least about 10⁻³ S/M. Materials having a conductivity of from about 10⁻² to about 10⁶ S/M are preferred.) As this range of conductivities reflects, these layers 10 and 14 can be layers of conductive or semiconductive polymers or they can be conductive or semiconductive metallic layers such as an aluminum, copper, or silver layer. They can also be conductive and semiconductive inorganic compounds such as conductive or semiconductive metal oxides and sulfides. They can also be formed of conductive or semiconductive organic polymers. The conductive first and third layers 10 and 14 can be composed entirely or substantially of such conductive materials and may be applied directly onto opposing sides of the intermediate layer 12 such as by printing, by coating with a solution of the material, by chemical deposition such as by vapor depositing or sputtering. The layers 10 and 14 themselves can be made up a conductive layer and a substrate, most commonly a plastic substrate. Metallized polyamides such as metallized “nylon” and metallized polyesters such as polyethyleneterephthalate (“metallized Mylar”) are examples of commercially-available plastic substrates bearing a conductive metal layer.

If a substrate material is used, it is generally preferred to arrange the layers such that the substrate is placed away from the middle (“second”) layer 12 and not between the middle layer 12 and the conductive coating of either of the conductive first and third layers 10 and 14. The thickness of these first and third layers is not critical and can range from a nanometer or so in the case of directly-deposited layers without a substrate to up to 50 microns or so when including a plastic substrate which typically will be in the 5-50 micron range of thickness. If substrated conductive layers 10 and 14 are used, they need to be fastened to the intermediate layer 12. This can be carried out using adhesives or thermal lamination methods. What is important is that these layers 10, 12 and 14 be robust and flexible and conformable to the object to which the label is attached.

The second layer 12 is formed from a material which may be an insulator or a semiconductor or conductor of lower conductivity than the first and third layers 10 and 14, for example having a conductivity that is from about 1×10⁻² to about 1×10⁻⁶ times the conductivity of the first and third layers 10 and 14. This layer 12 should have a substantial thickness, for example from about a few (5) microns to about 1 or 2 millimeters and particularly from about 10 microns to about 1 millimeter. This layer 12 separates the first and third layers 10 and 14. The material of layer 12 should be deformable and compressible, such as resilient foam or plasticized polymer. It can be an organic polymer foam or a plasticized organic polymer sheet. As noted, at times it is desired to have a degree of electrical conductivity in layer 12. This conductivity can be imparted to the material of later 12 by incorporating conductive or semiconductive organic polymers or liquids into the material of layer 12 or by incorporating conductive or semiconductive particles such as carbon or metal particles into the material of layer 12.

The relationship among these three layers, with a pair of conductive layers 10 and 14 separated by a deformable compressible middle layer 12 creates a characterizable electrical signature for the label 100. That is, there is a characteristic resistance, a characteristic conductance, a characteristic capacitance and the like in label 100 when it is applied to the object being monitored which can be measured across layers 10 and 14. When a force or pressure is applied to the three layer stack, this force can deform and compress at least in part the middle layer 12. This compression or deformation will have the effect of altering the electrical characteristics or signature of the label 100. This altering will be observed most commonly as decreasing the resistance, increasing the conductivity and changing the capacitance measured across layers 10 and 14. If the layer 12 is conductive or semiconductive, this will typically reduce layer 12's resistance or increase its conductivity. If layer 12 is substantially insulative, the compression or deformation will alter the capacitance measured across layers 10 and 14.

The labels of this invention generally can include a number of conventional additional label components as well. They can include printing on their outer surface. They can include a substrate or backing on their inner surface. This is present to provide mechanical strength to the label. They can include a layer of adhesive (shown as 22 on FIG. 1), most commonly a pressure-sensitive adhesive on their inner surface or on the inner surface of the substrate or backing, if present to adhere the label to the object. They can also include a removable secondary backing sheet common to virtually all pressure sensitive-adhesive labels which covers the adhesive layer before use to protect it and which is stripped away to expose the layer of adhesive just before the label is applied to the object.

In FIG. 1A, a label 100 is shown attached to container 16 made up of cap 18 and body 20 with adhesive layer 22. When a current or voltage is fed across layers 10 and 14 using power source 24 and conductors 26 and 28, a signature signal, which can be based upon resistance, conductivity, current, capacitance, etc, is detected and measured by detector 30, shown schematically and representationally as meter 30. Meter 30 reads a value for the electrical signature that is depicted in the drawing as falling within a characteristic base range “B” as shown by the position of meter needle 32. This characteristic signature range takes into account standard variation that would be caused by the environment in which the system is placed, for example variable conditions such as temperature and humidity, movement of the system itself and casual handling of the container 16 with the label 100 attached.

In FIG. 1B, a finger 34 is seem pushing down on label 100. This could be done to access a freshness or pressure seal integrity button (not shown) under label 100 on the top 18 of container 16. This freshness or pressure seal integrity button is the type of button which is resilient and flexes in and out when depressed when the container is intact and the container's internal atmosphere is under pressure. Such a button does not exhibit resiliency and is immovable if the container seal has been broken and the container's pressure released. As finger 34 pushes down on label 100 it distorts and collapses layer 12 to a characteristic extent. There could be a different characteristic degree of collapse depending upon whether or not the freshness and security seal was resilient or not resilient. This collapse or distortion of layer 12 causes a change in the electrical signal or signature measured by detector 30. This is shown in FIG. 1B by the movement of needle 32 to a value “M” which is distinguishable by detector 30 from value “B”.

Thus, label 100 provides an electrical indication as to whether of not the freshness or seal integrity button was accessed. In a simple manual operation of the device, an operator could note the signature of the label, in this case the amount of needle deflection, and write down whether the deflection indicated an intact seal or a ruptured seal and the time of the notation. Alternatively, in a more automated embodiment, the signature could be determined automatically and stored in a computer memory along with information concerning the time and date of the accessing.

As shown in FIG. 2, in another form of detector, the power source 24 and detector 30 could be incorporated into the cap 18 of the container 16 with the label 100 still on the outside of cap 18 in a position where it would be contacted in a characteristic way which would distort and or compress layer 12 each time the object (freshness button or seal integrity button) was accessed. The cap could contain additional electronics such as clock 36, memory 38 and signaling unit 40 which could gather and store and transmit information concerning the integrity of the package, based upon the contacting of the freshness button through the layer 100 as well as the time of the contacting, thus producing a record of the integrity of the package over time.

It will be appreciated that the label can be placed on container 16 in a number of alternate locations or could be used to provide a range of indications of manipulation besides that just described. For example, if container 16 is a drug container and cap 18 is a “child proof” cap which requires a downward force to unlatch, label 100, placed as shown, could give an indication of each time the cap 18 is depressed to open the container 16. This could provide a record of when the patient removed doses of drug from the container 16. Alternatively, the label could be wrapped and affixed circumferentially around the cap 18. If cap 18 was a security closure which required a pinching or tight grasping to activate, the force of the pinching or grasping could be used to distort or compress layer 12 and generate an electronic signature change measured across layers 10 and 14 as an indication of accessing of the contents of the container 18. Again, this signal or signature change could be stored or used as desired.

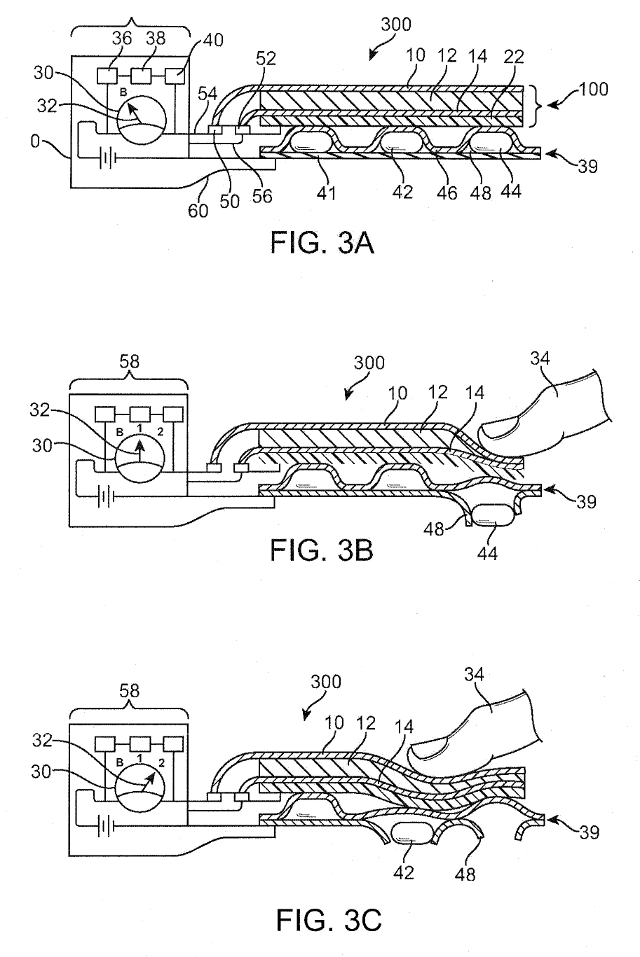

As shown in FIGS. 3A-C, the label of this invention 100 can be used in overall system 300 in conjunction with a conventional blister package 39 of the type used to dispense medication unit dosage forms (pills, capsules, etc) and also to dispense other small objects such as bolts, automotive parts, hardware and the like. As previously discussed, label 100 includes conductive layers 10 and 14 separated by compressible/distortable spacer layer 12. Label 100 is adhered to blister pack 39 by adhesive layer 22. Blister pack 39 contains a plurality of objects 41, 42 and 44, individually packed between flexible layer 46 and frangible flexible layer 48. Conductive layers 10 and 14 are electrically coupled via electrical contacts 50 and 52 and conductors 54 and 56 to the detector 58 which is shown enclosed within housing 60. Detector 58 includes meter 30 with needle 32 which is depicted to represent generically any type of detector which would register the electrical signature of the label 100 when layers 10 and 14 are connected into the detector circuit and would register changes in this signature when layer 12 is compressed or distorted. The detector 58 further includes other components such as the timer, memory and communication components identified as 36, 38 and 40 and previously discussed.

As depicted in FIG. 3A, when all of the objects are present in blister pack 39 and no distortive or compressive force is being applied to label 100, meter 30 and needle 32 register a “B” or base value for the electrical signature of label 100.

In FIG. 3B, finger 34 is seen pushing down on label 100 thus applying a layer 12 distorting force to label 100. This distorting force is being transmitted through to blister pack 39 where it is sufficient to push object (pill) 44 through layer 48 for dispensing to the user. As this happens, the electrical signature detected by meter 30 and needle 32 changes to a value “1”. This value is the signature characteristic of the dispensing of a first object 44 from the blister pack 39. The detector 58 can create a record of this event including information as to when it occurred.

In FIG. 3C, finger 34 can be seen repeating the expressing of an object out of the blister pack 39. In this case, object (pill) 42 is being dispensed to the user. Again, the force needed to express the object 42 through frangible layer 48 is also sufficient to further compress and/or deform compressible/deformable layer 12 in label 100. This compression/distortion, taken together with some or all of the compression/distortion that occurred when object 44 was removed, leads to yet a new electrical environment within label 100 which leads to a yet different signature signal being sent and detected by detector 58. This new signal is shown on meter 30 as needle 32 position “2”.

Thus, using the label 100 it is possible to detect not only single events but also multiple events, whether simultaneous multiple events or sequential multiple events.

It can be seen that in system 300, the label 100, the blister pack 39 and the detector 58 can all be joined into a single unit. This enables a standard blister pack to be used. Since the label 100 does not rely upon the breaking of breakable fine wires, printed traces or the like other traces to provide the signal of object access, the alignment of the label and the blister is not critical. This is an advantage that has universal application. It makes it possible for the label and the object (blister pack, container, etc) that the label is monitoring to be quickly assembled in the field away from complicated assembly equipment.

The detector 58 shown in FIG. 3 will typically continuously or periodically monitor the electrical signals from the label 100. When a change in one or more of these signals is detected it is transmitted to a central processor including components 36, 38 and 40 as previously described. The central processor reads the appropriate time associated with the detected signal as obtained from a time keeping unit 36, and this time information related to the accessing event is stored in memory 38. The time resolution of this event record is given by the accuracy of the time-keeping circuit and the frequency with which the central processor inspects the digital signals from the detector. The time resolution should be such as to lead to meaningful data concerning the accessing events. For example to give information as to a patient's compliance with a drug dosing regimen or lack thereof.

In one embodiment, the conductive layers 10 and/or 14 or the less conductive compressible/deformable layer 12 are implemented using one or more electrically-conducting organic materials such as the conductive organic polymer marketed as Baytron™.

An advantage of conductive polymers in this application is that they can be applied as thin-film sheets of conductive/semiconductive polymer or they can be cast in place as such layers.

In preferred embodiments, some or all of the layers 12, 14 and/or 16 make use of organic conductors and/or organic semiconductors. Conductive polymers include conjugated polymers. These are described, for example at, Chemical Innovation, Vol. 30, No. 1, 14-22 (April 2000), and in the report entitled “P-235 Conductive Polymers” by Mel Schlecter, published October 2003 by Business Communications Company, Inc. Representative conductive polymers include poly(aniline), poly(acetylene), poly(N-vinylcarbazole), poly(pyrrole), poly(thiophene), poly(2-vinylpyridine), poly(p-phenylenevinylene), poly(naphthalene) and related derivatives. Some of the conductors can be formed of carbon fibers and the like, or can incorporate carbon fibers or particles if desired.

The labels of this invention include a layer of adhesive 22. This adhesive is commonly a pressure sensitive adhesive such as a polyolefin or polyacrylate and can be present with or without a substrate or backing layer. A substrate, if present, can be formed of common flexible film-forming structural polymers such as polyethyleneterephthalate and other polyesters, olefin polymers such as polyethylene, aromatic polymers such as polystyrene and the like.

In the systems of this invention the processor, which is usually physically connected to the detector through the flexible substrate and electrically through carious conductive circuitry on the substrate, provides the functional electronic building blocks that are required for at least the reception of the detected dispensing event signals and generally the storage of this event information and the transmission of the information, as detected or after storage, to an outside system.

In these systems, the processor can include signal comparators for detecting these signal modifications, clocking and absolute time-keeping circuits, a central processor that monitors the detector signaling circuits and stores detected dispensing events together with their time in appropriate memory cells, a wireless radio-frequency or optical communication interface for transmitting all this information to an outside system, optional sensor modules such as temperature, touch sensing or other devices for patient input, an optional display or enunciator module for providing visual or audible feedback to the patient, all powered by the power-supply such as a battery or photovoltaic cell, with this detector and processor.

This processor can also provide an information retrieval and retransmission system that can read the data provided by the detector and transmit it either to the medication-prescribing physician or to an organization that collects and compiles such data as indications of the times at which medication doses were taken in order to present the data to the medication-prescribing physician in appropriate form.

This detection can be specific for individual dosage forms or it can be based on the overall collection of dosage forms, depending upon whether or not information concerning specific individual doses is needed as would likely be the case if the system were monitoring the dispensing of doses of more than one drug with a single device. The processor obtains this information, combines it with an absolute or relative time stamp that is received from a clock generator and timing circuit, and the combined information can be stored in a digital memory.

The system can also contain a wireless communication module, with which the central processor can communicate the medication removal events to the information retrieval and retransmission system. This process is implemented either as a radio-frequency link or an optical link, preferentially using infrared light as known from television remote controls.

Once the power supply is connected to the system, the clock generation module begins to operate and the central circuit is initialized. The absolute timing circuit either resets itself to zero before running continuously, or it can obtain the correct, absolute time from a radio station emitting standard time signals, such as the long-wave DCF77 time signal (77.5 kHz) provided by the German Physikalisch-Technische Bundesanstalt PTB or the WWVB time signal (60 kHz) provided by the US National Institute of Standards and Technology NIST.

The medication removal events together with their appropriate time stamps are most commonly stored by the central processor in the digital memory. This information can be read out and transmitted from time to time to an offsite information retrieval and retransmission system. Since the distance between this information retrieval and retransmission system and the medication event detection system of this invention is not known, there might be the need to provide the detection systems' wireless communication module with quite a high level of transmitted RF or optical power.

An alternative is to store all information in the unitary system processor memory until all of the unit doses of medication have been dispensed or the medication regimen has come to a close. The patient can then place the used detector-processor unit together with its flexible substrate into a container or receptacle which is stored at a location conducive to effective transmission of data, such as for example a location in the patient's home, which is combined with the information retrieval and retransmission system.

What is claimed is:

1. A conformable label for attachment to the object,
the label comprising a stack of layers and an adhesive coating,
the stack of layers comprising first, second and third layers,
the first and third layers each comprising flexible, conformable, electrically conductive or semiconductive material and each comprising an electrical contact point for connection into an electrical circuit,
the second layer comprising a flexible, deformable and compressible material, said second layer being electrically nonconductive or electrically conductive but less conductive than the first and third layers, said second layer separating said first and third layers,
with the adhesive coating being suitable for attaching the stack of layers to the object.

2. The label of claim 1 wherein the label detects when the object is physically accessed and wherein the label is adapted for being attached to the object in a location selected to receive a second-layer-deforming compressive force when the object is accessed.

3. The label of claim 2 wherein the second layer is electrically nonconductive.

4. The label of claim 2 wherein the second layer is electrically conductive.

5. The label of claim 2 wherein the second layer has an initial configuration before receiving a second-layer-deforming compressive force and a second configuration when receiving the second-layer-deforming compressive force and a third configuration after receiving the second-layer-deforming compressive force and wherein the initial configuration and the third configuration are substantially indistinguishable.

6. The label of claim 2 wherein the second layer has an initial configuration before receiving a second-layer-deforming compressive force and a second configuration when receiving the second-layer-deforming compressive force and a third configuration after receiving the second-layer-deforming compressive force and wherein the initial configuration and the third configuration are distinguishable.

7. The label of claim 2 wherein one or both of the first and third layers comprise more than one electrical contact points for connection into an electrical circuit.

8. An electrical-signal-providing label system for detecting a physical accessing event involving an object comprising a label of claim 2 for attachment to the object and an electrical detection circuit connected to the label at the connection points on the first and third layers.

9. The electrical-signal-providing label system of claim 8 capable of
detecting a first output signal across the first and third layers with the label in place attached to the object and no access to the object having been achieved,
detecting a second output signal across the first and third layers, said first and second output signals being similar to each other if no access to the object has been achieved and said first and second output signals differing from one another in a characteristic way if the object has been accessed.

10. The electrical-signal-providing label system of claim 8 capable of
feeding a first fed electrical signal across the first and third layers,
detecting a first output signal across the first and third layers with the label in place attached to the object and no access to the object having been achieved,
feeding a second fed electrical signal across the first and third layers with the label in place,
detecting a second output signal across the first and third layers, said first and second output signals being similar to each other if no access to the object has been achieved and said first and second output signals differing from one another in a characteristic way if the object has been accessed

11. An electrical-signal-providing label system for detecting physical accessing events involving first and second objects comprising a label of claim 2 for attachment to the first and second objects and an electrical detection circuit connected to the label at the connection points on the first and third layers.

12. The electrical-signal-providing label system of claim 11 capable of
detecting a first output signal across the first and third layers with the label in place attached to the first and second objects and no access to the first and second objects having been achieved,
detecting a second output signal across the first and third layers, said first and second output signals being similar to each other if no access to the first and second objects has been achieved and said first and second output signals differing from one another in a characteristic way if the first object has been accessed and differing from one another in a characteristic way if the second object has been accessed, and differing from one another in a characteristic way if the first and second objects have both been accessed.

13. An electrical-signal-providing label system for detecting the dispensing of a dose of medication from a container to a patient comprising a label of claim 2 for attachment to the container and an electrical detection circuit connected to the label at the connection points on the first and third layers.

14. The electrical-signal-providing label system of claim 13 capable of
detecting a first output signal across the first and third layers with the label in place attached to the container and no dispensing of a dose of medication from the container to the patient having been achieved,
detecting a second output signal across the first and third layers, said first and second output signals being similar to each other if no dispensing of a dose of medication from the container to the patient has been achieved and said first and second output signals differing from one another in a characteristic way if the dispensing of a dose of medication from the container to the patient has been achieved.

15. An electrical-signal-providing label system for detecting the dispensing of a series of doses of medication from a container to a patient comprising a label of claim 2 attached to the container and an electrical detection circuit connected to the label at the connection points on the first and third layers.

16. The electrical-signal-providing label system of claim 15 capable of
feeding a first fed electrical signal across the first and third layers,
detecting a first output signal across the first and third layers with the label in place attached to the container and no dispensing of a dose of medication from the container to the patient having been achieved,
feeding a second fed electrical signal across the first and third layers with the label in place,
detecting a second output signal across the first and third layers, said first and second output signals being similar to each other if no dispensing of a dose of medication from the container to the patient has been achieved and said first and second output signals differing from one another in a characteristic way if dispensing of a dose of medication from the container to the patient has occurred,
over a period of time feeding a sequence of additional fed electrical signals across the first and third layers with the label in place, and
over the period of time detecting a sequence of additional output signals across the first and third layers, said additional output signals being similar to the second output signal if no additional dispensings of a dose of medication from the container to the patient have occurred and the additional output signals differing from the second output signal in a characteristic way if a second dispensing of a dose of medication from the container to the patient has taken place and differing from one another in a characteristic way if yet additional dispensings of a dose of medication from the container to the patient have taken place.
